(19) United States
(12) Patent Application Publication
(10) Pub. No.: US 2012/0043468 A1
(43) Pub. Date: Feb. 23, 2012

(54) SEMICONDUCTOR PHOTODETECTORS WITH INTEGRATED ELECTRONIC CONTROL

(76) Inventors: Frederick Flitsch, Cornwall, NY (US); Daniel Codi, Florida, NY (US)

(21) Appl. No.: 13/212,851

(22) Filed: Aug. 18, 2011

Related U.S. Application Data
(60) Provisional application No. 61/375,025, filed on Aug. 18, 2010.

(51) Int. Cl. G01T 1/20; G01T 1/26

(52) U.S. Cl. 250/366; 250/371

(57) ABSTRACT

Composite photodetection devices are described comprising layers with different photodetector embodiments, in connection through vias in bonded layers with electronic circuitry upon them. Standard photodetectors with isolation structures are defined as well as photodetectors with the capability for avalanche operation. Still further embodiments with micropixel embodiments comprising silicon photomultipliers are also described. Embodiments with incorporated transistors are also defined. Methods of using the attached electronics associated with each pixel element to define novel operational set points for the composite photodetector devices are also described.

### CROSS-REFERENCE TO RELATED APPLICATION

This application claims the benefit of U.S. provisional patent application No. 61/375,025, filed Aug. 18, 2010, entitled “SEMICONDUCTOR PHOTODETECTORS WITH INTEGRATED ELECTRONIC CONTROL AND SENSING” and incorporated herein by reference.

### BACKGROUND OF THE INVENTION

1. Field of the Invention

The present invention relates to the field of photodetectors and methods of integrating photodetectors in a 3D fashion electronics into the solid state assembly.

2. Prior Art

In prior applications including those referenced herein, photodetectors of various types have been described. In some of the main embodiment types these photodetectors are deployed in a solid state array to detect light with two dimensional location resolution. In some of the implementations, the photodetects are simple PIN detectors. Additional forms may include avalanche photodetectors where the PIN Structure is altered in such a manner to obtain gain within the body of the photodetector itself. These detectors may be additionally made more sophisticated by enabling the detectors to operate in a Geiger mode of operation and then breaking the individual photodetector pixels to be proken down to sub pixels which act as digital counting devices.

Advancement in processing technology may be obtained by processing the mentioned different types of photodetector sensor layers in manners that allow the integration of a photosensor layer with an electronic layer. There may be numerous manners that devices may be processed in this fashion including growing different layers vertically with epitaxial growth and bonding different layers together in some cases including thru silicon vias to connect the different device and electronic layers.

The incorporation of electronics at a three dimensional perspective enables electronics to be designed to control, sense and act upon individual photodetector elements. There may be numerous important applications that such an integration scheme may enable.

### BRIEF DESCRIPTION OF THE DRAWINGS

FIG. 1 is a schematic cross-section of a standard PIN Photodetector pixel element of an array or single photodetector showing the integration of electronics to the detector thru the use of thru silicon vias.

FIG. 2 is a schematic cross-section of an exemplary avalanche pixel element of an array or single photodetector showing the integration of electronics to the detector thru the use vertical structure growth by epitaxial growth.

FIG. 3 is a schematic cross-section of an exemplary Silicon Photomultiplier pixel element of an array or single photodetector showing the integration of electronics to the detector thru the use of thru silicon vias.

FIG. 4 is a schematic cross-section of an Photodetector pixel element with inherent transistor action of an array or single photodetector also showing the integration of electronics to the detector thru the use vertical structure growth by epitaxial growth.

### DETAILED DESCRIPTION OF THE PREFERRED EMBODIMENTS

The current invention depicts embodiments of back-illuminated photodetector structures that combine the advantages of current photodetectors or photodetector arrays with individualized electronics. This electronics in some embodiments may further act in manners that combine or process signals from multiple pixel elements or the electronics connected to multiple pixel elements.

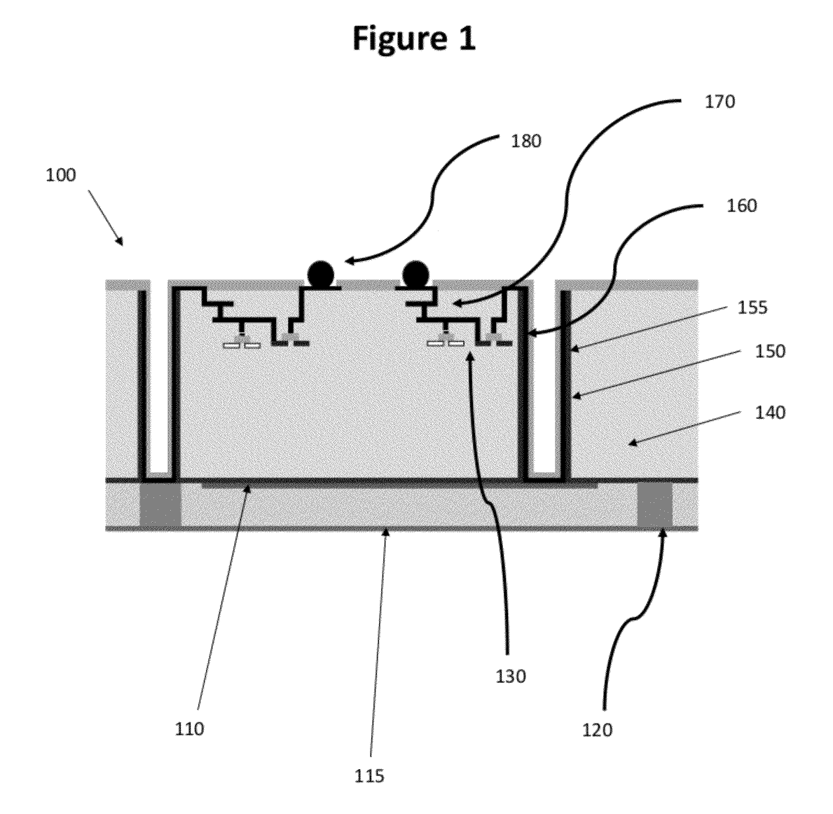

In an exemplary embodiment, referring to FIG. 1, item 100 a photodetector array with integrated electronics is depicted. In this example, the electronics are shown in an embodiment where a processed electronics wafer 140, with functional transistors 130, has been bonded to a separate sensor layer at an interface, 105. It may be noted, that the definition of the layers that are bonded to each other and the exact location of the interface, 105 may have various definitions consistent with the spirit of the invention herein.

In some embodiments the sensor layer may be a photodetector as shown in FIG. 1. The anode of this photodetector layer 110, and the cathode of the photodetector layer 115 are shown. In some embodiments the separation of the anode and cathode may be characterized as “thin” and may be on the order of 20 to 100 angstroms thick. As well, some embodiments may contain features that connect or isolate features on one side of the layer from the other. For example, item 120 may represent a diffused layer where one conductivity type has been diffused from one side of the sensor layer to the other. Alternative embodiments may be defined where the layer is diffused from either or both sides. Still further embodiments, may derive from the integration of silicon trenches into the region denoted by item 120. Numerous embodiments of photodetector devices with pixel isolation may be consistent with the spirit of the invention herein.

The device depicted in item 100 includes a second region Item 140, that is connected to the photodetector. In some embodiments, the region may be directly bonded to the photodetector or alternatively there may be layers that are inbetween the photodetector and the second region. In a non limiting sense, item 140 may be comprised of a silicon wafer upon which an electronic circuit has been formed. Transistors of various kinds making up the electronic circuit may occur in this region 140 as shown as items 130. These transistors, and more generally any electronic component that can be formed on a silicon wafer, may be interconnected by numerous layers of interconnect metallurgy as depicted by item 170. These layers of interconnect may terminate at a surface and have contact points where interconnect to devices outside this device may be made. In some embodiments this interconnect may occur through the use of solder balls, as shown as item 180 in the figures.

The photodiode layer in some embodiments may be connected to the electronics layer through the use of vias that span the region 140. These vias may be represented by item 160. The via may be formed by etching away the silicon or other body material creating access to a contact point on the photodiode. Then a metal layer item 155 may be used to connect the photodiode to the electronic circuit. In some embodiments the metal layer might be isolated from the silicon body 140, by an insulator layer 150. The insulator may be comprised of any acceptable insulating material, and one such example may be silicon oxide. There may be numerous manners to form an interconnection between a photolayer and an attached electronics layer.

The device as shown as item 100 allows for each pixel element to have attached to it unique electronic circuitry both for control functions and also for sensing purposes. Among, in a non limiting sense, the possible functions of the circuitry may be the ability to bias the anode 110 or the cathode 115 in certain ways through their interconnection. In addition current flowing through the photodiode may also be sensed through either or both of the connections to these elements. It may also be apparent that higher level functions may be formed in the electronics and the connections to the sensing elements. In a non limiting example, a circuit to integrate charge flowing through a cathode may convert this current into a voltage signal. Then electronics that may input this voltage may then convert this voltage into a digital value. In some embodiments, circuits that amplify currents or voltage may be included in the circuitry of the electronics. Additional circuitry may control the timing of acquisition and transmission of the various data values. In some other embodiments, the circuitry may include memory elements that may temporarily store the data values and or other controlling aspects of the circuitry. In some embodiments the electronics may include microcontrolling circuits to allow for the programming of various functions of the electronics connected to the sensor layers or electronics downstream of such connection. There may be numerous embodiments of the circuitry that may be connected to a sensor in the type of art defined herein. Additionally, there may be numerous methods to incorporate such electronics into the device and to use such electronics to form a function together with the sensing element, photodiode.

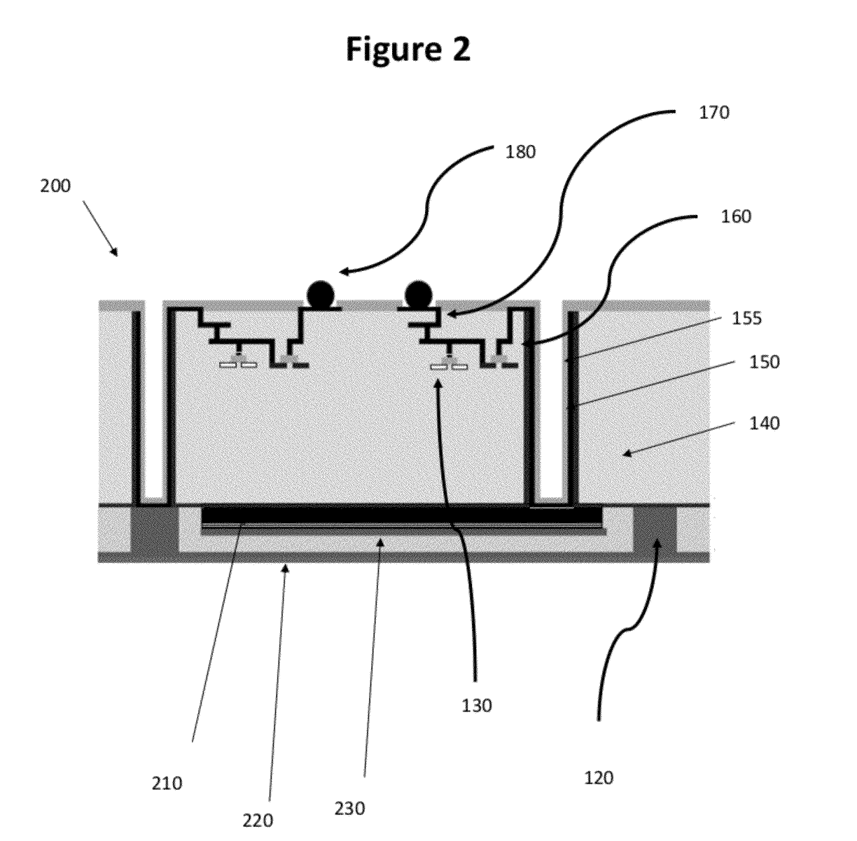

In FIG. 2 an alternative embodiment of the core concepts is depicted. The items in the figures that are numbered equivalently as in FIG. 1 in some embodiments, may have the same function as discussed in the previous sections. What may be different in item 200, is that the photodetector may be formed in a different manner. In some embodiments, item 220 may comprise the cathode layer for the photosensing layer. Then item 210 again may define an anode region. To alter the standard photodetector characteristics to define an avalanche photodiode, additional layers shown as item 230 may be added to change the electrical properties of the device. As in previous discussion, the feature 120 may define a manner of electrically isolating one pixel from another pixel in an array. The multitude of manners of fashioning an Avalanche Photodiode together with isolation features comprise art within the scope of this invention.

When an avalanche photodiode is connected in the manners as described herein, the function of the electronics may derive the diversity of functions that have been described in conjunction with the standard photodiode. Additionally, however it may be effective to include circuit function in a device of this type that performs a self calibration role. If a signal was inputted into the electronics of the device through an external signal location, like item 180 for example, it could be used to set the electronics into such a self calibration role. If the photon flux impinging on the surface of the avalanche photodiode is a standard flux then in some embodiment, the electronics could vary key parameters like in a non limiting example the potential bias applied between the anode and cathode, then the detected signal could be set to result in a defined and targeted signal result. Such a function, may in some embodiments be uniquely enabled by having electronics deployed and active on a pixel by pixel basis and very close to the pixel location for advantages in signal to noise and feedback concerns. It may be obvious to one skilled in the arts that numerous additional calibration methodologies are consistent with the art described herein.

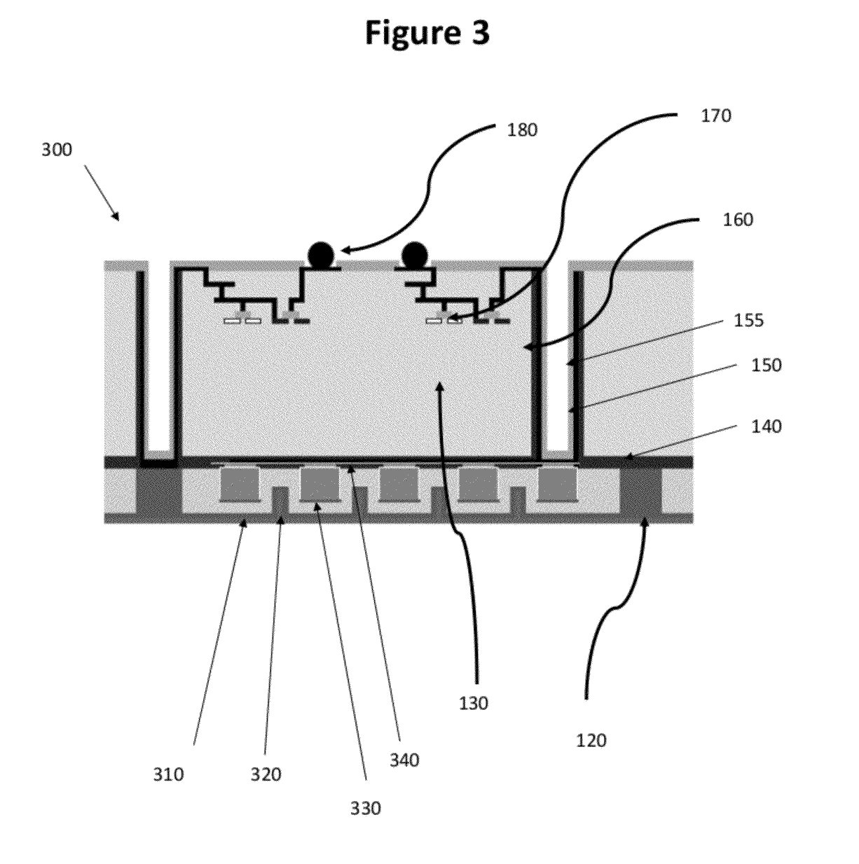

In FIG. 3 an alternative embodiment of the core concepts is depicted. The items in the figures that are numbered equivalently as in FIG. 1 in some embodiments, may have the same function as discussed in the previous sections. What may be different in item 300, is that the photodetector may be formed in a different manner to form a silicon photomultiplier device. In some embodiments, item 310 may comprise the cathode layer for the photosensing region. Item 330 may define an anode region; however as can be seen in FIG. 3, in some embodiments, the device 300 comprises numerous cathode regions, that may be referred to as micropixels. In some embodiments these micropixels may all be joined together by a metallurgical layer; and in these embodiments the individual micropixels define a single output signal for a pixel. In many embodiments of such a device, the signal of each micropixel will be set up to represent a large current spike for each incident photon on the micropixel. Electronics connected to the pixel may be configured to react to each of these spikes of current as a “count” of each photon incident on the detector. Again, the presence of electronics for each pixel provides unique enablement of the counting function to be associated uniquely with each pixel location.

The various electronic functions that are associated with the previous devices 200 and 100 may also function for device 300, however the geometry of the device 300 provides some other unique functions that the electronics may perform. In a non limiting example, if the voltage that is applied between the cathode and anode is adjusted, in some embodiments the device may be able to switch between modes where it is enabled for counting single photon events on each micropixel. If the setpoints on the bias are altered, the device may be enabled to perform like a more standard photodetector with response signals in an analog manner. In some embodiments, the control bias may comprise high voltage. Certain types of electronics capable of high voltage operation (Like for example High Voltage CMOS) may be the electronics found in the electronics layer. The enablement of the individual electronics for each pixel may define numerous functions related to the geometry of devices of the type as depicted in FIG. 300.

With the micropixel orientation of device 300, an alternative set of embodiments may be enabled if the individual micropixels are independently sourced. Depending on the size of the multipixels and of the vias, in some embodiments each of the micropixels may be controlled and sourced to electronics through an independent via. In other embodiments, collections of a subset of micropixels per pixel may be connected and sensed and controlled by electronics through connecting vias.

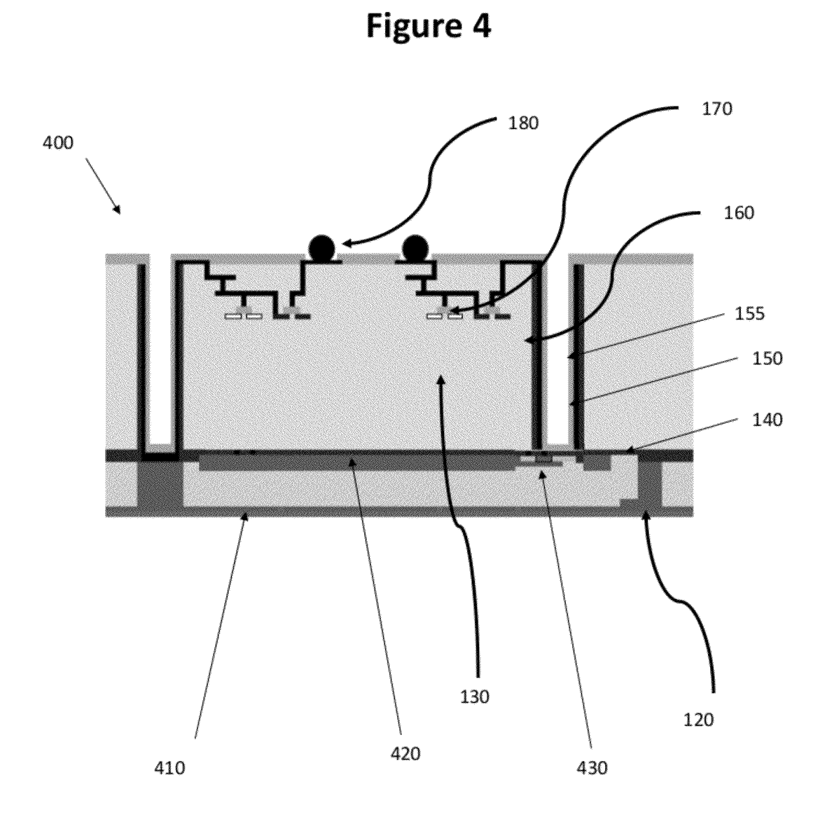

In FIG. 4 an alternative embodiment of the core concepts is depicted. The items in FIG. 4 that are numbered equivalently as in FIG. 1 in some embodiments, may have the same function as discussed in the previous sections. What may be different in item 200, is that the photodetector may be formed in a different manner. In some embodiments, item 410 may comprise the cathode layer for the photosensing layer. Item 420 again may define an anode region. In these embodiment types the anode of the detector is connected to a transistor for amplification within the body of the photodetector. In some embodiments, this transistor may be of a JFET type in others it may comprise a bipolar type transistor. There may be numerous manners to incorporate a transistor into the device of the type shown as item 400 which may be connected to electronics in a manner consistent with the art contained herein. And, it may be apparent that the various embodiment diversity described in connection with the function of attached electronics may also comprise embodiments of devices of type 400 as well.

The various embodiments of photodetector arrays that may be built from sensor layers with attached electronics connected through vias in the intermediate layers as has been mentioned herein may be assembled into sub-systems that utilize the photodetector arrays and therefore create new embodiments of the invention herein. In an embodiment of this invention of this type an imaging system for medical imaging or other applications includes a radiation sensitive detector with a pixilated scintillator array optically coupled to the isolated pixels semiconductor photo-sensitive device.

Yet another embodiment of the present invention implies use of the primary photodetector array of the embodiments described herein and the whole detector system that incorporate the said primary photodetector arrays in applications like Computed Tomography (CT), Positron Emission Tomography (PET), Single Photon Emission Computing Tomography (SPECT). Optical Tomography (OT), Optical Coherent Tomography (OCT) and the like.

While the invention has been described in conjunction with specific embodiments, it is evident that many alternatives, modifications and variations will be apparent to those skilled in the art in light of the foregoing description. Accordingly, this description is intended to embrace all such alternatives, modifications and variations as fall within its spirit and scope.

What is claimed is:

1. A radiation detection system comprising:
A composite photodetection device wherein a photo-sensitive device having multiple photo-sensitive elements is arrayed upon a first semiconductor layer and is connected to a second semiconductor layer through vias in the body of the second semiconductor layer,
also having isolation regions in the first semiconductor layer surrounding the periphery of each of the multiple photo-sensitive elements, but not necessarily abutting them, wherein said isolation spans the semiconductor layer;
at least a scintillator element which converts x-ray radiation into light, upon the semiconductor substrate; and,
at least one electrical amplification element formed in electrical circuitry which has been formed into the second semiconductor layer within the composite.

2. A method of operating a composite radiation detection device comprising:
Providing an electrical signal to a composite radiation device comprising a photodetection array with micropixels configured for Geiger mode avalanche action and a semiconductor layer with high voltage cmos circuitry upon it and a through silicon via connecting an element in the photodetection array to the high voltage cmos circuitry;
Biasing the micropixels through the high voltage cmos circuitry for Geiger mode operation of the said micropixels;
Subsequently biasing the micropixels through the high voltage cmos circuitry to act as photodiodes without avalanche operation.

3. A method of operating a composite radiation detection device comprising:
Providing an electrical signal to a composite radiation device comprising a photodetection array with pixels configured for avalanche action and a semiconductor layer with cmos circuitry upon it and a through silicon via connecting an element in the photodetection array to cmos circuitry;
Biasing the pixels through cmos circuitry dedicated to the operation of the said pixel for Avalanche mode operation where the bias voltage is individually defined for each of the said pixels in the array.

4. A radiation detection system comprising:
A composite photodetection device wherein a photo-sensitive device having multiple photo-sensitive elements is arrayed upon a first semiconductor layer and is connected to a second semiconductor layer through vias in the body of the second semiconductor layer,
also having isolation regions in the first semiconductor layer surrounding the periphery of each of the multiple photo-sensitive elements, but not necessarily abutting them, wherein said isolation spans the first semiconductor layer;
a transistor element within the first semiconductor layer connecting a portion of the photosensitive element to the said via;
at least a scintillator element which converts high energy radiation into light, upon the semiconductor substrate; and,
at least one electrical amplification element formed in electrical circuitry which has been formed into the second semiconductor layer within the composite.
